(19) United States
(12) Patent Application Publication
(10) Pub. No.: US 2019/0001438 A1
(43) Pub. Date: Jan. 3, 2019

(54) Method for producing a pre-coated metal sheet

(71) Applicant: ARCELORMITTAL, Luxembourg (LU)

(72) Inventor: Wolfram EHLING, Gent (BE)

(73) Assignee: ArcelorMittal, Luxembourg (LU)

(21) Appl. No.: 16/064,096

(22) PCT Filed: Dec. 22, 2016
(86) PCT No.: PCT/EP2016/082412

§ 371 Date: Jun. 20, 2018

(30) Foreign Application Priority Data
Dec. 22, 2015 (IB) PCT/IB2015/059889

(51) Int. Cl. B23K 26/26; B23K 26/042; B23K 26/08; B23K 26/142; B23K 26/362; B23K 26/322; C22C 38/32; C22C 38/28; C22C 38/06; C22C 38/04; C22C 38/02; C22C 38/00; C21D 1/18; C21D 6/00; C23C 2/12; C23C 2/26; C23C 2/40

(52) U.S. Cl. CPC B23K 26/26; C21D 2211/008; B23K 26/08; B23K 26/142; B23K 26/362; B23K 26/322; C22C 38/32; C22C 38/28; C22C 38/06; C22C 38/04; C22C 38/02; C22C 38/002; C22C 38/001; C21D 1/18; C21D 6/008; C21D 6/005; C21D 6/002; C23C 2/12; C23C 2/26; C23C 2/40; B23K 26/042

(57) ABSTRACT

This method for preparing a pre-coated metal sheet for welding thereof to another pre-coated metal sheet, containing the following successive steps:
providing a pre-coated metal sheet containing a metal substrate provided, on at least one of its faces, with a pre-coating layer, then
removing, on at least one face of said pre-coated metal sheet, at least part of said pre-coating layer so as to form a removal zone, said removal being done by the impact of a laser beam on said pre-coating layer, the removal step comprising, over the course of the removal, the relative displacement of said laser beam with respect to the metal sheet in a direction of advance (A).

During the removal, the laser beam is inclined relative to the face of the metal sheet such that the orthogonal projection of the laser beam on said face of the metal sheet is located in the zone of the metal sheet in which the removal has already been done, and it forms an angle of inclination (a) of between 12° and 50° with the direction normal (N) to the face of the metal sheet.

### FIELD OF THE INVENTION

The present invention relates to a method for preparing a pre-coated metal sheet for welding thereof to another pre-coated metal sheet, comprising the following successive steps:
providing a pre-coated metal sheet comprising a metal substrate provided, on at least one of its faces, with a pre-coating layer, then
removing, on at least one face of said pre-coated metal sheet, at least part of said pre-coating layer so as to form a removal zone, said removal being done by the impact of a laser beam on said pre-coating layer, the removal step comprising, over the course of the removal, the relative displacement of said laser beam with respect to the metal sheet in a direction of advance.

### BACKGROUND OF THE INVENTION

Patent application EP 2 007 545 describes a method for manufacturing a welded part from a metal sheet pre-coated with a pre-coating, the pre-coating comprising a layer of intermetallic alloy topped by a layer of metal alloy. During this method, before welding, in order to limit the proportion of pre-coating melted during the subsequent welding, at the periphery of the metal sheet, at least part of the pre-coating is removed by ablation using a laser beam, while retaining at least part of the layer of intermetallic alloy so as to protect zones located on either side of the weld joint from corrosion.

Publication KR 10-1346317 describes a method during which a coating based on aluminum and silicon is removed at the periphery of a metal sheet before welding. KR 10-1346317 teaches inclining the head of the laser relative to the vertical by an angle comprised between 5° and 10° in order to prevent the beam reflected by the metal sheet from striking the optics of the laser. KR 10-1346317 does not specify on which side the head of the laser must be inclined relative to the displacement direction of the laser during the removal.

### BRIEF SUMMARY OF THE INVENTION

One object of the invention is to provide a method for preparing a pre-coated metal sheet for welding thereof to another pre-coated metal sheet making it possible to obtain a weld joint having satisfactory mechanical properties for a reduced ablation duration of the pre-coating.

The invention provides a method for preparing a pre-coated metal sheet as cited above, in which, during the removal, the laser beam is inclined relative to the face of the metal sheet such that the orthogonal projection of the laser beam on said face of the metal sheet is located in the zone of the metal sheet in which the removal has already been done, and it forms an angle of inclination comprised between 12° and 50° with the direction normal to the face of the metal sheet.

In certain embodiments of the method:
the pre-coating layer is a layer of aluminum, an aluminum-based layer or a layer of aluminum alloy;
the pre-coating layer is a layer of aluminum alloy further comprising silicon;
the incline angle of the laser beam is comprised between 15° and 45°;
the incline angle of the laser beam is comprised between 20° and 40°;
the incline angle of the laser beam is comprised between 25° and 40°;
the incline angle of the laser beam is comprised between 25° and 35°;
the laser beam is a pulsed laser beam;
during the removal step, the distance between the output lens of the laser head and the metal sheet is greater than or equal to 150 mm, and in particular comprised between 150 mm and 250 mm;
the removal is done without gas blowing;
the removal is done without suction;
the pre-coating layer comprises a layer of intermetallic alloy topped by a layer of metal alloy;
the removal zone is completely free of the layer of metal alloy;
the removal zone is formed on a lower face of the metal sheet;
a removal zone is formed simultaneously on a lower face and on an upper face of the metal sheet;
the metal substrate is made from steel;
the steel of the substrate comprises, by weight:
   0.10%≤C≤0.5%,
   0.5≤Mn≤3%,
   0.01≤Si≤1%,
   0.1≤Si≤1%,
   Ti≤0.2%,
   Al ≤0.1%,
   S≤0.05%,
   P≤0.1%,
   B≤0.010%,
   the rest being iron and impurities from smelting;
the steel of the substrate comprises, by weight:
   0.15% ≤C≤0.25%,
   0.8≤Mn≤1.8%,
   0.1%≤Si≤0.35%,
   0.01≤Cr≤0.5%,
   Ti≤0.1%,
   Al≤0.1%,
   S≤0.05%,
   P≤0.1%,
   B≤0.005%,
   the rest being iron and impurities from smelting;
the steel of the substrate comprises, by weight:
   0.040%≤C≤0.100%,
   0.80≤Mnv 2.00%,
   Si≤0.30%,
   S≤0.005%,
   P≤0.030%,
   0.010%≤Al≤0.070%,
   0.015%≤Nb≤0.100%,
   Ti≤0.080%,
   N≤0.009%,
   Cu≤0.100%,
   Ni≤0.100%,
   Cr≤0.100%,
   Mo≤0.100%,
   Ca≤0.006%,
   the rest being iron and impurities from smelting;
the microstructure of said steel is ferrito-pearlitic;
during the provision step, two pre-coated metal sheets are supplied and they arearranged side by side, leaving a predetermined gap between the two pre-coated metal sheets, then, during the removal step, at least part of the pre-coating layer is simultaneously removed from each of the two metal sheets in order to simultaneously form a removal zone on each of said metal sheets, the laser beam being arranged overlapping the two metal sheets during the removal step;
the removal zone is located at the periphery of the metal sheet;
the removal zone is not completely adjacent to the edge of the metal sheet;
the method further comprises, after the removal step to form the removal zone, cutting of the metal sheet along a plane so as to form a metal sheet comprising, at its periphery, a zone free of at least part of the pre-coating layer.

The invention also provides a metal sheet comprising a metal substrate provided, on at least one of its faces, with a pre-coating layer, the metal sheet comprising, on said at least one face, a removal zone where the pre-coating layer has been removed over part of its thickness.

In certain embodiments:
in the removal zone, the relative variation 4, considered along the width of the removal zone, of the thickness of the part of the pre-coating layer remaining in the removal zone, defined as the ratio of the difference between the pre-coating thickness at half-width and the pre-coating thickness at one third of the width considered from the edge of the removal zone to the thickness of the pre-coating at half-width is strictly greater than 0% and less than or equal to 50%;
the pre-coating layer comprises a layer of intermetallic alloy topped by a layer of metal alloy;
the removal zone is completely free of the layer of metal alloy;
the removal zone is located at the periphery of the metal sheet;
the removal zone is not completely adjacent to the edge of the metal sheet.

The invention also provides a method for manufacturing a welded blank, comprising the following successive steps:
providing at least two metal sheets as described above, in which the removal zone is located at the periphery of the metal sheet or obtained from at least one metal sheet in which the removal zone is not completely adjacent to the edge of the metal sheet, by cutting in the removal zone so as to obtain a metal sheet comprising, at its periphery, a zone free of at least part of the pre-coating layer or manufactured using the aforementioned manufacturing method, then
butt welding these two metal sheets, the welded connection being done on the edge comprising the removal zone.

In certain embodiments of this method, the two butt welded metal sheets have different thicknesses.

The invention also provides a method for manufacturing a hot pressed part comprising the following successive steps:
providing a welded blank obtained using the method as described above, then
heating said welded blank so as to impart a partially or fully austenitic structure to the substrates of the metal sheets making up said blank, then
hot press-forming said blank to obtain a hot pressed part;
cooling the part with a speed able to give it targeted mechanical properties.

In certain embodiments of this method, the cooling speed is greater than the critical martensitic quenching speed of the steel of the substrate of said at least two metal sheets or the steel of the substrate of said at least one metal sheet.

### BRIEF DESCRIPTION OF THE DRAWINGS

The invention will be better understood upon reading the following description, provided solely as an example and done in reference to the appended drawings, in which:

FIG. 1 is a schematic illustration of an initial pre-coated metal sheet;

FIG. 2 is a schematic illustration of a metal sheet obtained using the preparation method;

FIG. 3 is a schematic illustration of a metal sheet according to one alternative;

FIG. 4 is a schematic illustration of the removal, i.e., ablation step of the production method,

FIG. 5 is a graph showing the treatment speed as a function of the angle of inclination of the laser beam;

FIG. 6 is a transverse schematic view of the geometry of the ablation zone, obtained under conditions of the invention when the laser beam is inclined with an angle a comprised between 25° and 50°; and

FIG. 7 is a schematic perspective illustration of the removal step of the production method.

### DETAILED DESCRIPTION OF THE INVENTION

The invention provides a method for preparing a pre-coated metal sheet for the welding thereof to another part, in particular to a second pre-coated metal sheet produced similarly.

The method according to the invention comprises:
providing an initial pre-coated metal sheet 1 comprising a metal substrate 3 bearing, on at least one of its faces, a pre-coating layer 5; and
removing, on at least one face 10 of said initial pre-coated metal sheet, at least part of said pre-coating layer 5.

FIG. 1 shows an example of an initial pre-coated metal sheet 1 provided in the provision step of the method according to the invention.

In the context of the present invention, the expression “metal sheet” is to be understood broadly and in particular refers to any strip or any object obtained by cutting from a strip, spool or sheet. In the particular case illustrated in FIG. 1, this metal sheet 1 includes two faces 10 and four edges 13. However, the invention is not limited to this particular geometry.

As illustrated in FIG. 1, the pre-coated metal sheet 1 comprises a metal substrate 3 bearing, on at least one of its faces, a pre-coating layer 5 superimposed on the substrate 3 and in contact therewith.

The substrate 3 is advantageously a substrate made from steel.

The steel of the substrate 3 is more particularly a steel whose microstructure is ferrito-pearlitic. The substrate 3 is advantageously a steel for heat treatment, in particular a press-hardenable steel, and in particular a manganese- and boron-based steel, such as a steel of type 22MnB5.

According to one embodiment, the steel of the substrate 3 comprises, by weight:
0.10%≤C≤0.5%,
0.5≤Mn≤3%,
0.01≤Si≤1%,
0.1≤Si≤1%,
Ti≤0.2%,
Al≤0.1%,
S≤0.05%,
P≤0.1%,
B≤0.010%,
the rest being iron and impurities from smelting.

In certain embodiments, the steel of the substrate 3 comprises, by weight:
0.15%≤C≤0.25%,
0.8≤Mn≤1.8%,
0.1%≤Si≤0.35%,
0.01≤Cr≤0.5%,
Ti≤0.1%,
Al≤0.1%,
S≤0.05%,
P≤0.1%,
B≤0.005%,
the rest being iron and impurities from smelting.

Alternatively, the steel of the substrate 3 comprises, by weight:
0.040%≤C≤0.100%,
0.80≤Mn≤2.00%,
Si≤0.30%,
S≤0.005%,
P≤0.030%,
0.010%≤Al≤0.070%,
0.015%≤Nb≤0.100%,
Ti≤0.080%,
N≤0.009%,
Cu≤0.100%,
Ni≤0.100%,
Cr≤0.100%,
Mo≤0.100%,
Ca≤0.006%,
the rest being iron and impurities from smelting.

As an example, the metal substrate 3 is obtained, depending on the desired thickness, by hot rolling, or by cold rolling followed by annealing, or by any other appropriate production method.

The substrate 3 advantageously has a thickness comprised between 0.5 mm and 4 mm, and in particular equal to about 1.5 mm.

The pre-coating layer 5 is a layer obtained by dipping, i.e., by immersion in a molten metal bath. It comprises a layer of intermetallic alloy 9 in contact with the substrate 3 topped by a layer of metal alloy 11.

The layer of intermetallic alloy 9 results from the reaction between the substrate 3 and the molten metal of the bath. This layer of intermetallic alloy 9 comprises an intermetallic compound comprising at least one element of the layer of metal alloy 11 and at least one element of the substrate 3. Its thickness is generally around several micrometers. In particular, its mean thickness is typically comprised between 2 and 7 micrometers.

The layer of metal alloy 11 has a composition very close to the composition of the molten metal of the bath. It results from the entrainment of part of the molten metal from the bath by the strip during its displacement through the bath. Its thickness is controlled using appropriate control elements, arranged at the outlet of the bath, and in particular using gas jets, and in particular air or nitrogen jets. It for example has a mean thickness comprised between 19 μm and 33 μm or a mean thickness comprised between 10 μm and 20 μm.

The pre-coating layer 5 is more particularly a layer of aluminum, a layer of aluminum alloy or an aluminum-based alloy layer. In this case, the layer of intermetallic alloy 9 comprises intermetallic compounds of type Feₓ—Al_{y}, and in particular Fe₂Al₅.

“Aluminum alloy” refers to an alloy comprising more than 50% by weight of aluminum.

“Aluminum-based alloy” means an alloy in which aluminum is the majority component by weight.

According to one embodiment, the pre-coating layer 5 is a layer of aluminum alloy further comprising silicon. As an example, the layer of metal alloy 11 comprises, by weight:
8%≤Si≤11%,
2%≤Si≤4%,
the rest being aluminum and possible impurities.

The particular structure of the layers of the pre-coating 5 obtained by dip-coating is in particular described in patent application EP 2 007 545.

Advantageously, and as shown in FIG. 1, the substrate 3 is provided with such a pre-coating layer 5 on each of its two faces 10.

Advantageously, the initial pre-coated metal sheet 1 is obtained by cutting, in particular by shearing or laser cutting, from a pre-coated strip having the properties mentioned above.

Following the provision step, the method according to the invention comprises removing, on at least one face 10 of said initial pre-coated metal sheet 1, at least part of said pre-coating layer 5 in a removal zone 7.

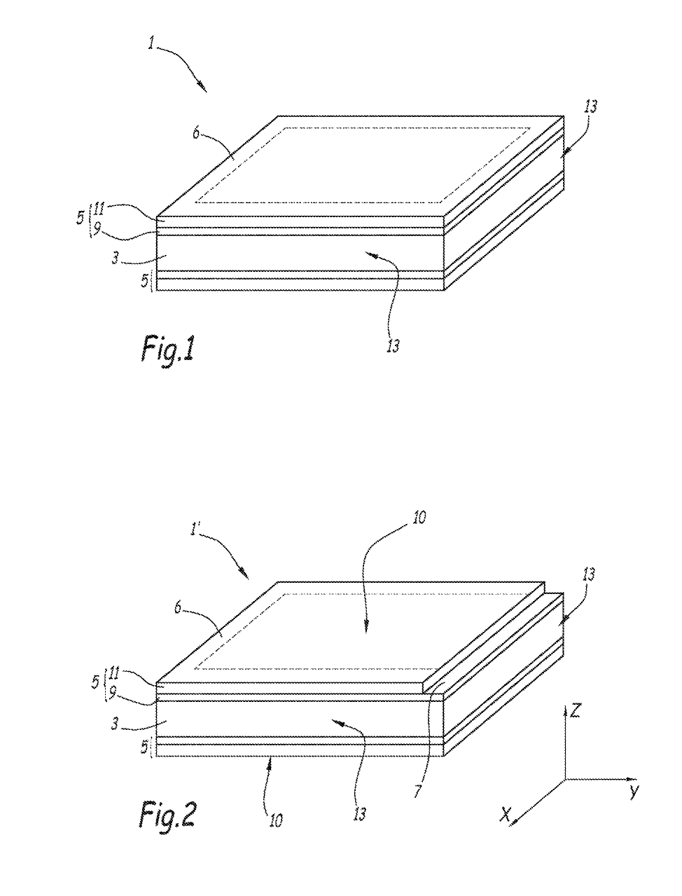

FIG. 2 illustrates a metal sheet obtained after removal.

In the example illustrated in FIG. 2, the removal zone 7 is located at the periphery 6 of the initial pre-coated metal sheet 1.

Advantageously, during this step, the layer of metal alloy 11 is completely removed.

The removal of at least part of the pre-coating layer 5 is advantageous. Indeed, without removal, during the welding of the pre-coated metal sheet to another metal sheet, part of the pre-coating layer 5 is diluted with the substrate 3 within the molten zone, which is the zone brought to the liquid state during the welding operation and which solidifies after this welding operation while forming the connection between the two metal sheets.

Two phenomena may then occur:
according to a first phenomenon, an increase in the aluminum content in the molten metal, resulting from the dilution of a part of the pre-coating within this zone, leads to the formation of intermetallic compounds. These can be fracture initiation sites in case of mechanical stress.
according to a second phenomenon, the aluminum, alphagene element in solid solution in the molten zone, delays the transformation into austenite of this zone during the heating step preceding the hot press-forming. It is then no longer possible to obtain, in the molten zone, a completely quenched structure after the cooling following the hot forming, and the weld joint includes ferrite. The molten zone then has a lower hardness and mechanical tensile strength than the two adjacent metal sheets.

In the context of the preparation method according to the invention, it is therefore desired to reduce the amount of elements of the pre-coating layer 5 that may get into the molten zone and negatively influence its mechanical properties.

The inventors of the present invention have observed that satisfactory results are obtained in terms of mechanical properties of the weld joint when, for an aluminum-based pre-coating layer 5, at the end of the removal step, the part of the pre-coating layer 5 that remains has a mean thickness at most equal to about 5 μm. In view of the mean thickness of the intermetallic alloy layer 9 typically obtained during dip-coating of a steel metal sheet with an aluminum-based pre-coating, this thickness corresponds to a complete removal of the metal alloy layer 11 and to a possibly partial removal of the layer of intermetallic alloy 9.

Preferably, during this removal step, the layer of intermetallic alloy 9 is allowed to remain, at least partially, over the entire surface of the removal zone 7. Advantageously, at the end of this step, a layer of intermetallic alloy 9 remains with a thickness at least equal to 1 μm.

It is advantageous for at least part of the layer of intermetallic alloy 11 to remain in the removal zone 7. Indeed, in practice, in order to account for any fluctuations in the width of the molten zone during the welding operation, the width of the removal zone 7 is greater than the width of the molten zone during welding. After the welding operation, regions therefore remain on either side of the weld joint in which the pre-coating layer 5 has been at least partially removed. Yet one purpose of the aluminum-based pre-coating layer 5 is to protect the metal sheet 1 from corrosion after hot press-forming of the weld joint. Studies have shown that, in these regions of the removal zone 7 adjacent to the weld joint, having at least part of the intermetallic alloy layer 9 remain over the entire surface of these regions made it possible to impart sufficient protection against corrosion to the welded assembly.

In particular, a layer of intermetallic alloy with a thickness at least equal to 1 pm at all points of the zone 7 is left in the removal zone 7 in order to provide satisfactory corrosion resistance to the welded assembly in the regions adjacent to the weld joint.

Alternatively, it is possible to completely remove the layer of intermetallic alloy 11 in the removal zone 7 in cases where corrosion resistance is less critical.

According to the invention, the at least partial removal of the pre-coating layer 5 is done using a laser beam 15 striking the pre-coating layer 5.

FIGS. 4 to 6 schematically show, in side view, the removal step using a laser beam 15.

The laser beam 15 is emitted by a laser head 17.

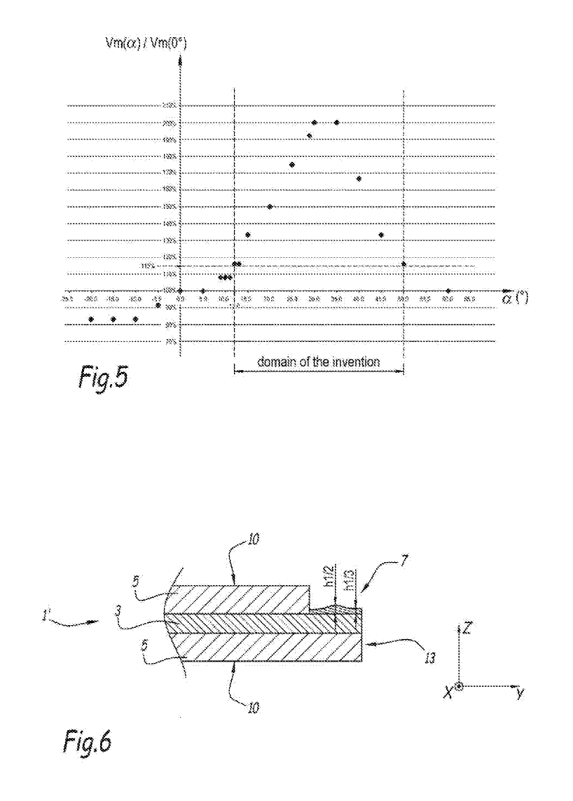

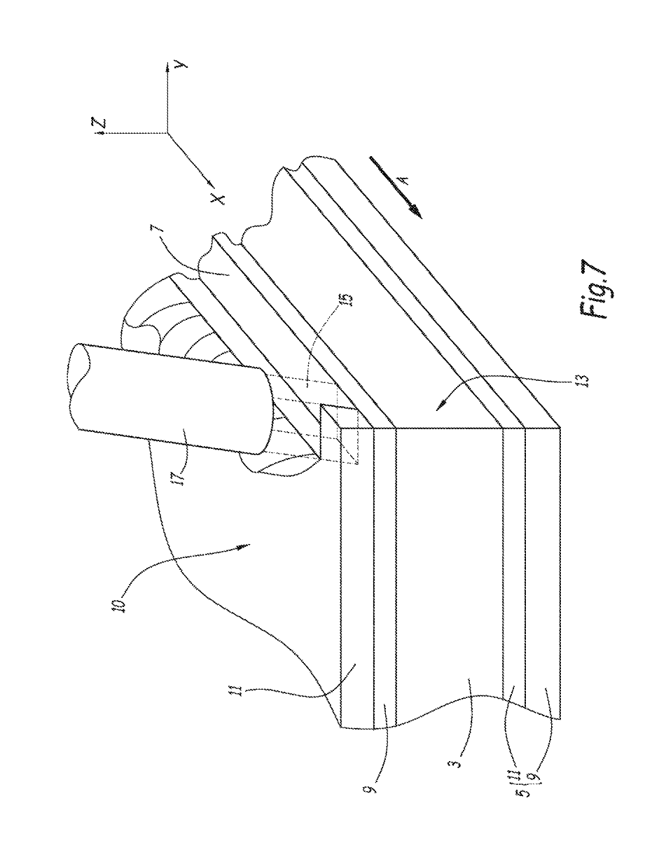

The removal step comprises, over the course of the removal, the relative displacement of the laser beam 15 with respect to the metal sheet 1 in a direction of laser advance denoted A. This direction of advance is illustrated by arrows in FIGS. 4 and 6.

The relative displacement of the laser beam 15 in the direction of advance A for example corresponds to:
a displacement of the laser beam 15 in the direction A, the metal sheet 1 remaining stationary; or
a displacement of the metal sheet 15 in the direction opposite A, the laser beam 15 remaining stationary; or
a displacement of both the laser beam 15 along A and the metal sheet 1 in the direction opposite A.

As an example, during the removal step, a laser beam 15 having the following characteristics is used:

The laser beam 15 advantageously has a rectangular or square cross-section.

As an example, the laser beam 15 produces, on the face 10 of the metal sheet 1 to be treated, a focal spot with a surface area comprised between 0.4 mm² and 3 mm², and advantageously comprised between 0.7 mm² and 1.5 mm².

The laser is preferably a pulsed laser, for example a laser of the Q-switch type, a pulsed fiber laser or a pulsed diode laser.

The pulse duration is of the order of the nanosecond. It is in particular comprised between 1 ns and 300 ns, and preferably between 10 ns and 150 ns, still more preferably between 30 ns and 80 ns.

The rated power of the laser beam 15 is in particular comprised between 200 W and 1.7 kW, and preferably between 400 W and 1.7 kW.

Preferably, during the removal step, the working distance, corresponding to the distance between the output lens of the laser head 17 and the face 10 to be treated of the metal sheet 1, is greater than or equal to 150 mm.

Indeed, during the removal step, the projections resulting from the ablation by the laser beam 15 are projected to a height smaller than or equal to 100 mm relative to the face 10 being treated. This projection height is even less than or equal to 50 mm for the majority of the projections. Consequently, a working distance greater than or equal to 150 mm makes it possible to avoid any risk of pollution of the lenses of the laser head by any projections resulting from the ablation by the laser beam 15. It will be noted that projections on elements of the laser head 17 located between the output lens and the face 10 being treated, and in particular on any protection elements, intended to protect the output lens from projections, do not pose problems in the context of the method according to the invention.

Advantageously, this working distance is comprised between 150 mm and 250 mm.

Indeed, the use of a working distance greater than 250 mm in particular results in significantly increasing the costs of the removal step, since it requires the use, in the optics of the laser, of nonstandard lenses, and in particular larger than the lenses typically used, as well as a larger number of lenses than the number of lenses necessary when the working distance is comprised in the range indicated above.

Preferably, this working distance is comprised between 190 mm and 215 mm.

According to the invention, during the removal step, the laser beam 15 is oriented in a specific manner relative to the metal sheet 1.

The specific orientation of the laser beam 15 during the removal step is illustrated schematically in FIG. 4.

FIGS. 1 to 6 have been provided with a coordinate system (x, y, z) in order to facilitate the description of the orientations hereinafter. As one can see, the axis x of this coordinate system is oriented in the direction of advance A of the laser beam 15. The axis z of the coordinate system is oriented along the thickness of the metal sheet 1 while being oriented starting from the half-thickness of the substrate 3 toward the ablation surface, i.e., upward in the case where the ablation is done on the upper face 10 of the metal sheet 1 and downward when the ablation is done on the lower face 10 of the metal sheet 1. The axis y of the coordinate system is orthogonal to the axes x and z, while being oriented so as to form a direct coordinate system with these two axes x, z.

The lower face 10 is the face oriented downward during the implementation of the removal step. The upper face 10 is the face oriented upward during the implementation of the removal step.

As illustrated in FIG. 4, during the removal, the laser beam 15 is inclined by an angle of inclination a relative to the normal N to the face 10 of the metal sheet 1 on which the removal is done, said normal N being taken in the zone of the metal sheet 1 in which the removal has already been done. This angle α is the angle between the axis L of the laser beam 15 and the normal N to the face 10 of the metal sheet 1 on which the removal is done, said normal N being taken in the zone of the metal sheet 1 in which the removal has already been done.

This angle of inclination a is an acute angle. An acute angle refers to an angle comprised strictly between 0° and 90°, the boundaries being excluded. The laser beam 15 is further inclined such that the orthogonal projection of the axis of the laser beam 15 on the face 10 of the metal sheet 1 being treated is located in the zone of the metal sheet 1 in which the removal has already been done. Thus, the laser beam 15 is emitted forward in the direction of advance A toward the face 10 of the metal sheet 1 to be treated. In other words, the emitting head 17 of said laser beam 15 is located at the rear, in the direction of advance A, of the impact zone of the laser beam 15 on the metal sheet 1.

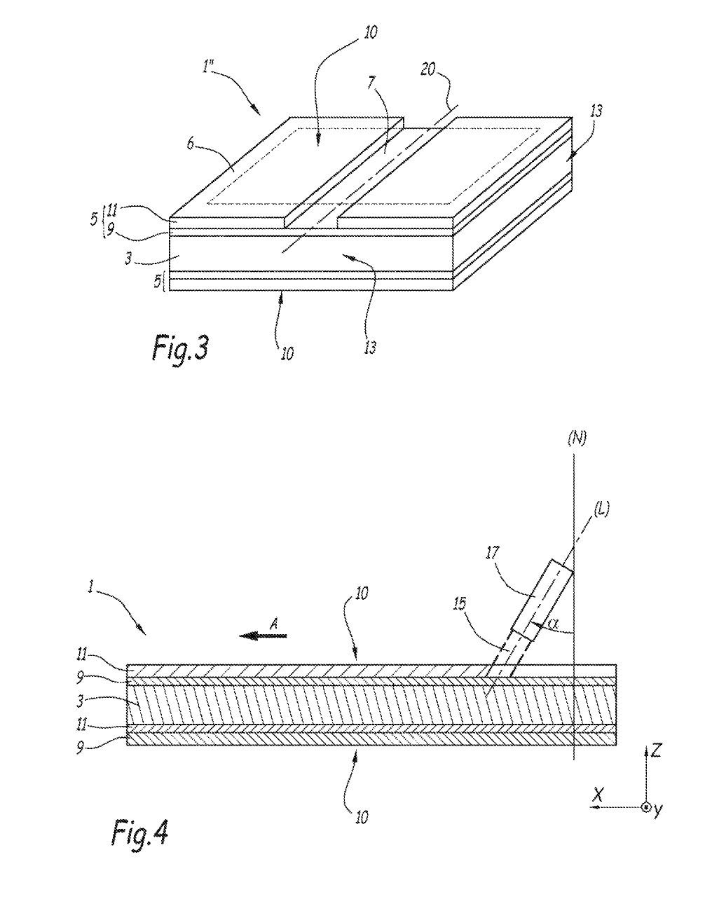

As illustrated in FIGS. 3 and 4, the laser beam 15 forms an obtuse angle with the zone of the face 10 of the metal sheet 1 located downstream from the impact zone of the laser beam 15 in the direction of advance A, i.e., with the region of the metal sheet remaining to be treated, and an acute angle with the zone of the face 10 of the metal sheet upstream from the impact zone of the laser beam 15, i.e., with the region of the metal sheet remaining to be treated.

It will be noted that the axis L of the laser beam 15 is completely comprised in a plane normal to the face 10 of the metal sheet 1 being treated and comprising the direction of advance A.

According to the invention, the angle of inclination a is comprised between 12° and 50°.

In the context of the present invention, for a given angle of inclination α of the laser beam 15, Vm is defined as the speed of advance of the laser beam 15 for which the entire layer of metal alloy 11 is removed, leaving in its place the entire layer of intermetallic alloy 9. Thus, for speeds of advance strictly greater than Vm, parts of said layer of metal alloy 11 remain in the zone 7.

The inventors of the present invention have noted, surprisingly, that when the laser beam 15 is inclined by the orientation described above during the removal, with an angle of inclination α comprised between 12° and 50°, the speed Vm (α) is greater by at least 15% than its value for an angle α equal to 0° (designated by))Vm(0)), i.e., for a laser beam 15 substantially perpendicular to the face 10 being treated. The angle α is therefore defined relative to the direction N, normal relative to the face of the metal sheet 1, as indicated in FIG. 4.

These results are illustrated in FIG. 5, which shows the evolution of the ratio) VM(α)/V(0°) as a function of the angle of inclination a obtained through experiments done by the inventors, which will be explained in more detail hereinafter.

Thus, the aforementioned orientation is advantageous, since it makes it possible to implement a speed of advance of the laser beam 15 at least 15% greater than the speed Vm allowable in the conventional case, in which the laser beam is oriented perpendicular to the face 10 to be treated, while obtaining a quality result at least identical in terms of removal quality. Yet such an increase in the advance speed results in a reduction in the treatment duration of the metal sheet 1 and therefore in an increase in the effectiveness of the method, which also results in reduced production costs.

Advantageously, the angle of inclination a is comprised between 15° and 45°.

Indeed, the inventors of the present invention have noted that, in this range of angles of inclination α, the speed Vm(α) is at least 25% greater than its value for an angle α equal to 0°, i.e., for a laser beam 15 substantially perpendicular to the face 10 of the metal sheet 1 being treated. This preferred range is more advantageous, since it allows an even greater reduction in the treatment duration of the metal sheet 1.

Still more advantageously, the angle of inclination a is comprised between 20° and 40°.

Indeed, the inventors of the present invention have noted that, in this range of angles of inclination α, the speed Vm(α) is at least 40% greater than its value for an angle α equal to 0°, i.e., for a laser beam 15 substantially perpendicular to the face 10 of the metal sheet 1 being treated. This preferred range is still more advantageous, since it allows an even greater reduction in the treatment duration of the metal sheet 1.

These results are also illustrated in FIG. 5.

Still more advantageously, the angle of inclination a is comprised between 25° and 35°. Indeed, as illustrated in FIG. 5, in this range of angles of inclination α, the speed Vm(α) is at least 75% greater than its value for an angle α equal to 0°, i.e., for a laser beam 15 substantially perpendicular to the face 10 of the metal sheet 1 being treated. This preferred range is still more advantageous, since it allows an even greater reduction in the treatment duration of the metal sheet 1.

As shown in FIG. 5, for angles of inclination α comprised between 30° and 35°, the speed Vm(α) is equal to twice its value for an angle α equal to 0°.

According to one embodiment, to perform the removal, a speed is chosen approximately equal to Vm such that the layer of metal alloy 11 is substantially completely removed in the removal zone 7 and the layer of intermetallic alloy 9 remains intact.

Alternatively, a speed of advance of the laser beam 15 is chosen lower than Vm so as to remove the layer of intermetallic alloy 9 at least partially over the entire surface of the removal zone 7. In this case, the inclination of the laser beam 15 in the range described above makes it possible to choose a speed of advance strictly greater than the speed of advance for a laser beam 15 normal to the face 10 to be treated for a removal result that is at least identical.

At the end of the removal step, a prepared metal sheet 1′ as illustrated schematically in FIG. 2 is obtained. This metal sheet 1′ has the following features.

It comprises a metal substrate 3 coated, on at least one of its faces 10, with a pre- coating layer 5 as previously defined, and has, on its periphery 6, a removal zone 7 free of at least part of the pre-coating layer 5.

The metal sheet 1′ is intended to be arranged alongside another metal sheet, then to be butt welded along a plane defined by the edge 13 of the metal sheet 1 located at the zone 7.

The zone 7 for example has a width comprised between 0.8 mm and 3 mm, and in particular between 0.8 mm and 2 mm. It extends along at least one edge 13 of the metal sheet 1.

In the example illustrated in FIG. 2, the metal alloy layer 9 has been completely removed from the zone 7, while retaining at least part of the intermetallic alloy layer 11 over the entire surface of the zone 7. More particularly, the layer of intermetallic alloy 11 remains intact in the zone 7. In this case, a speed of advance has been used equal to Vm during the removal step.

Alternatively, the layer of metal alloy 9 is removed completely in the zone 7 and the layer of intermetallic alloy 11 is removed partially over the entire surface of the zone 7.

According to another alternative, the layer of metal alloy 9 is removed completely in the zone 7 and the layer of intermetallic alloy 11 is removed completely over the entire surface of the zone 7.

In the example illustrated in FIG. 2, the removal zone 7 extends at the periphery of the metal sheet 6. Thus, it extends in a zone immediately adjacent to the edge 13 of the metal sheet. In this example, it extends parallel to the edge 13 over the entire length of said edge 13.

According to one alternative illustrated in FIG. 3, the removal zone 7 is located in a zone not completely adjacent to the edge 13 of the pre-coated metal sheet. As an example, it extends parallel to the edge 13 of the metal sheet over the entire length of said edge 13, at a predetermined non-nil distance from said edge.

According to this alternative, the metal sheet 1″ thus obtained is next cut along an axial plane 20 perpendicular thereto and intersecting the removal zone 7, in particular in the middle thereof. This cutting is for example done by slitting or laser cutting. A metal sheet 1′ as shown in FIG. 2 is then obtained.

As an example, according to the alternative, the aforementioned axial plane 20 passes through the middle of the removal zone 7, and the width of the removal zone 7 is 20% to 40% greater than the width of the molten zone that would be obtained by a welding operation carried out along the aforementioned axial plane 20. Advantageously, the width of the removal zone 7 is chosen such that after a welding operation done along the aforementioned axial plane 20, at least 0.1 mm of removal zone 7 remains on each side of the molten zone, considered along the width of the removal zone 7.

Alternatively, the width of the removal zone 7 is comprised between 0.4 mm and 30 mm. The minimum value of 0.4 mm corresponds to a width making it possible to produce, after cutting along the axial plane 20, two metal sheets having a very narrow removal zone of 0.2 mm on each of the two metal sheets. The value of 30 mm corresponds to a removal width well suited to industrial tools for such a removal. Subsequent cutting can be done, not on the axial plane 20 located at the middle of the removal zone, but in a suitable location so as to obtain a metal sheet whose removal width is slightly larger than the half-width of the molten zone obtained by a welding operation, defined by the conditions of the invention.

When the pre-coated metal sheet 1 has a pre-coating layer 5 on each of its faces, the removal step is advantageously carried out on each of its faces, either successively or substantially simultaneously, with a respective laser ablation head 17.

In this case, the metal sheet 1 has a removal zone 7 as previously defined on each of its faces 10, these removal zones 7 advantageously being located across from one another along the normal N to the metal sheet 1′.

According to one embodiment, the removal step of the method for producing a pre-coated metal sheet described above is carried out without blowing gas and/or without suction. Indeed, the use of blowing and/or suction jointly with an inclination of the laser beam 15 as described above risks reducing the stability of the removal method. In particular, the suction and blowing being done in specific directions, even a small error in the positioning of the blower nozzle or the suction nozzle risks resulting in an absence of ablation, at least localized, for ablation speeds greater than Vm(0).

In the context of the present invention, the inventors have carried out the following experiments, which have allowed them to obtain the curve illustrated in the aforementioned FIG. 5.

They started from metal sheets 1 cut from a strip of steel pre-coated by dip-coating in a molten bath of an aluminum alloy comprising 9.3% silicon and 2.8% iron, the rest being aluminum and unavoidable impurities. These metal sheets comprise, on each of their faces, a pre-coating layer 5 comprising a layer of an intermetallic alloy 9 comprising a majority of Fe2Al3, Fe2Al5 and FexAlySiz with a thickness approximately equal to 5 micrometers in contact with the steel substrate 3, topped by a layer 11 of Al—Si metal alloy with a mean thickness approximately equal to 24 micrometers.

The substrate 3 has the following composition, in percentage by weight:

| | | | | | | | | | | Fe and |
|---|---|---|---|---|---|---|---|---|---|---|
| | | | | | | | | | | unavoidable |
| C | Mn | Si | Al | Cr | Ti | B | N | S | P | impurities |
| 0.22 | 1.16 | 0.26 | 0.03 | 0.17 | 0.035 | 0.003 | 0.005 | 0.001 | 0.012 | Rest |

The layer of metal alloy 11 was next removed using a laser beam over a width of about 1.5 mm from the edge 13 of the metal sheets 1 using a laser beam 15 oriented at different angles of inclination α, while leaving the layer of intermetallic alloy 9 intact.

The removal was done using a pulsed fiber laser with a rated energy of 1000 W delivering pulses at a frequency of 10 kHz and producing a focal spot of about 1 mm². The pulse duration is approximately equal to 70 ns.

For each angle of inclination α, the corresponding speed Vm was measured.

These experiments made it possible to obtain the curve of FIG. 5, already previously analyzed.

Similar results were obtained by the inventors with other compositions of substrates 3, and in particular substrates 3 having the following composition, in % by weight: 0.04%≤C≤0.1%, 0.3%≤Mn≤2%, Si≤1.3%, Ti≤0.08%, 0.015%≤Nb≤1.1%, Al≤0.1%, S≤0.05%, P≤0.1%, Cu, Ni, Cr, Mo, less than 0.1%, the rest being iron and unavoidable impurities resulting from manufacturing, as well as with substrates 3 as specified above, coated with a pre-coating layer 5 having the composition mentioned above, but the total thickness of the pre-coating layer of which is about 35 micrometers.

Similar results have also been obtained by the inventors with lasers of the Q-switch type.

It will be noted that the curve of FIG. 5 also illustrates that the advantageous technical effect obtained by the invention is not obtained when the laser beam 15 is inclined such that its orthogonal projection on the face 10 being treated is in the zone of the face 10 remaining to be treated and not in the zone of this face already treated, corresponding to negative angles of inclination α.

Without wanting to be bound by a theory, the inventors of the present invention propose the following explanation for the observed advantageous effects of the inclination of the laser beam. They have observed that the impact of the laser beam 15 on the pre- coating layer 5 results in an explosion of the pre-coating in contact with the laser beam.

This explosion creates the formation of a metal vapor including, in suspension, particles from the pre-coating, vertically above the impact zone of the laser beam 15. When the laser beam 15 is oriented perpendicular to the plane of the face 10, i.e., when α=0°, it must traverse this cloud of particles over a substantial height and part of its energy is dissipated in the cloud before any useful impact with the pre-coating to be eliminated. On the contrary, when the laser beam 15 is inclined in the manner described above, it does not traverse the cloud of particles, or in any case traverses it less, which makes it more effective. When the laser beam 15 is inclined such that its orthogonal projection on the face 10 being treated is in the zone of the face 10 remaining to be treated and not in the zone of this face already treated, corresponding to negative angles of inclination, it must also traverse the cloud of particles over a substantial height and its effectiveness is therefore decreased similarly to the case of the beam 15 perpendicular to the plane of the face 10 to be treated.

In the context of the experiments done, the inventors of the present invention have noted that, when the laser beam 15 is inclined by an angle of inclination α comprised between 25° and 50°, the removal zone 7 obtained by ablation has, irrespective of the speed of advance of the laser beam 15, a significant surface homogeneity.

As an example, the table below illustrates the results of experiments done by the inventors of the present invention.

| | Angle of inclination α | Angle of inclination α |
|---|---|---|
| | beyond which a thickness | beyond which a thickness |
| Speed | inhomogeneity Δ ≤50% of | inhomogeneity Δ ≤70% of |
| of advance | the pre-coating is obtained | the pre-coating is obtained |
| 10 m/min | 22.5° | 20° |
| 11 m/min | 22.5° | 15° |
| 14 m/min | 25° | 0° |
| 17 m/min | 22.5° | 0° |

In this table, Δ represents, for a given cross-section through the removal zone 7, taken perpendicular to the edge 13 of the metal sheet 1′ adjacent to the zone 7, the relative difference between:
the thickness of the pre-coating remaining at one third of the width of the removal zone 7, considered from an edge of the removal zone 7 along the width of said zone, said edge corresponding, in this example, to the edge 13 of the metal sheet 1, denoted h⅓; and
the thickness of the pre-coating remaining at half-width of the removal zone 7, denoted h½.

FIG. 6 shows a schematic illustration of these parameters.

More particularly, Δ is obtained by applying the following formula:

$$Δ ( \% ) = \frac{{h}_{1 / 2} - {h}_{1 / 3}}{{h}_{1 / 2}} \times 100.$$

Thus, Δ constitutes a measure of the homogeneity of the thickness of the pre-coating remaining in the removal zone 7 at the end of the removal step.

In the preceding, pre-coating thickness refers to the thickness of the latter in the removal zone 7 measured from the substrate 3 in the direction normal to the face 10 of the metal sheet 1′.

In the table above, 50% means that the relative difference is less than or equal to 50%.

Δ≤70% means that the relative difference is less than or equal to 70%.

After ablation with an inclined beam, it is observed that h½>h⅓ (or equivalently: h½−h⅓>0), i.e., that the thickness of the coating at half-width is greater than that obtained moving away from this position. Thus, Δ>0%.

However, the experiments done by the inventors have shown that, over the width of the removal zone 7, a difference Δ less than or equal to 50% in pre-coating thickness is observed irrespective of the removal speed used when the angle of inclination α is greater than or equal to 25°.

On the contrary, the difference Δ is higher for smaller angles of inclination, the thickness of pre-coating remaining at half-width typically being at least twice that at one third of the width as defined above.

In practice, it will be noted that the thickness h⅓ of the pre-coating varies very little with the inclination of the laser beam 15. The improved homogeneity of the thickness of pre-coating remaining in the ablation zone 7 essentially comes from a reduction in the coating thickness h½ with the inclination of the laser beam 15, the thickness h½ approaching h⅓ for increasing inclinations of the laser beam 15.

Thus, the range of angles of inclination α comprised between 25° and 50° makes it possible to obtain both a substantial productivity of the removal method and a very good homogeneity of the thickness of pre-coating remaining in the removal zone 7.

This very good homogeneity is advantageous. Indeed, such a homogeneity makes it possible to minimize the aluminum content in the weld joint, while providing very good corrosion resistance in regions of the metal sheets 1 immediately adjacent to the weld joint while maximizing the thickness of the layer of intermetallic alloy 9 remaining in these regions.

As previously explained, the range of angles of inclination α comprised between 20° and 40° makes it possible to obtain an even better productivity. Thus, the range of angles of inclination α comprised between 25° and 40° makes it possible to obtain both a substantial productivity of the removal method and a very good homogeneity of the thickness of pre-coating remaining in the removal zone 7.

Similar conclusions apply in the case of a metal sheet 1′ in which the removal zone 7 is not adjacent to the edge 13. In this case, the edge of the removal zone 7 corresponds to one of the two edges of the removal zone, considered along the width of the removal zone.

Thus, the removal method according to the invention in this case makes it possible to obtain metal sheets 1′, 1″ as previously described, and for which, in the removal zone 7, the relative variation 4, considered along the width of the removal zone 7, of the thickness of the part of the pre-coating layer 5 remaining in the removal zone 7, defined by the ratio of the difference between the pre-coating thickness at half-width h½ and the pre-coating thickness h⅓ at one third of the width considered from said edge of the removal zone 7 to the thickness of the pre-coating at half-width h½ is strictly greater than 0% and less than or equal to 50%.

The invention also provides a method for manufacturing a welded blank, comprising:
providing at least two metal sheets 1′ produced according to the method described above;
butt welding these two metal sheets 1′, the welded connection being carried out on the edge 13 comprising the removal zone 7 in which the pre-coating layer 5 has been at least partially removed, and which is in particular free of metal alloy layer 11.

The welding method is advantageously a laser welding method with or without filler wire, depending on the composition of the metal substrate and desired mechanical properties of the weld joint. Alternatively, it is an electric arc welding method.

In certain embodiments, the metal sheets 1′ have identical thicknesses. In alternative embodiments, they have different thicknesses.

At the end of this method, a welded blank is obtained comprising two pre-coated metal sheets butt welded to one another.

According to one alternative embodiment, during the provision step, at least two metal sheets 1′ are provided, which have been obtained from at least one metal sheet 1″ as previously described by cutting in the removal zone 7′ so as to obtain a metal sheet 1′ comprising, at its periphery, a zone 7 free of at least part of the pre-coating layer 5.

The invention also provides a method for manufacturing a part successively comprising:
providing a welded blank obtained using the method as described above;
heating the blank so as to impart a partially or fully austenitic structure to the substrates of the metal sheets making up said blank;
hot forming said blank in order to obtain a part; and
cooling the part with a speed able to give it targeted mechanical properties.

Advantageously, during the cooling step, the cooling speed is greater than the critical martensitic quenching speed.

The part thus manufactured is, for example, a structural or safety part for a motor vehicle.

According to one embodiment that is not shown, during the provision step, two pre-coated metal sheets 1 are provided as described above and they are arranged side by side, leaving a predetermined gap between the two metal sheets, then, during the removal step, at least part of the pre-coating layer 5 is simultaneously removed from each of the two metal sheets 1 so as to simultaneously form a removal zone 7 on each of said metal sheets 1, the laser beam 15 being arranged overlapping the two metal sheets 1 during the removal step.

1-33. (canceled)

34. A method for preparing a pre-coated metal sheet for welding thereof to another pre-coated metal sheet, comprising the following successive steps:
providing a pre-coated metal sheet comprising a metal substrate provided, on at least one of its faces, with a pre-coating layer, then
removing, on at least one face of said pre-coated metal sheet, at least part of said pre-coating layer so as to form a removal zone, said removal being done by an impact of a laser beam on said pre-coating layer, the removal step comprising, over the course of the removal, the relative displacement of said laser beam with respect to the metal sheet in a direction of advance,
wherein during the removal, the laser beam is inclined relative to the face of the metal sheet such that the orthogonal projection of the laser beam on said face of the metal sheet is located in the zone of the metal sheet in which the removal has already been done, and wherein the laser beam forms an angle of inclination comprised between 12° and 50° with the direction normal to the face of the metal sheet.

35. The method according to claim 34, wherein the pre-coating layer is a layer of aluminum, an aluminum-based layer or a layer of aluminum alloy.

36. The method according to claim 34, wherein the pre-coating layer is a layer of aluminum alloy further comprising silicon.

37. The method according to claim 34, wherein the angle of inclination of the laser beam is comprised between 15° and 45°.

38. The method according to claim 34, wherein the angle of inclination of the laser beam is comprised between 20° and 40°.

39. The method according to claim 34, wherein the angle of inclination of the laser beam is comprised between 25° and 40°.

40. The method according to claim 34, wherein the angle of inclination of the laser beam is comprised between 25° and 35°.

41. The method according to claim 34, wherein the laser beam is a pulsed laser beam.

42. The method according to claim 34, wherein the pre-coating layer comprises a layer of intermetallic alloy topped by a layer of metal alloy.

43. The method according to claim 42, wherein the removal zone is completely free of the layer of metal alloy.

44. The method according to claim 34, wherein the removal zone is formed on a lower face of the metal sheet.

45. The method according to claim 34, wherein a removal zone is formed simultaneously on a lower face and on an upper face of the metal sheet.

46. The method according to claim 34, wherein the removal is done without suction.

47. The method according to claim 34, wherein the removal is done without gas blowing.

48. The method according to claim 34, wherein, during the removal step, the distance between the output lens of the laser head and the metal sheet is greater than or equal to 150 mm.

49. The method according to claim 34, wherein the metal substrate is made up of steel.

50. The method according to claim 49, wherein the steel of the substrate comprises, by weight:
0.10%≤C≤0.5%,
0.5≤Mn≤3%,
0.1≤Si≤1%,
0.01≤Si≤1%,
Ti≤0.2%,
Al≤0.1% S≤0.05%,
P≤0.1%,
B≤0.010%,
the rest being iron and impurities from smelting.

51. The method according to claim 49, wherein the steel of the substrate comprises, by weight:
0.15%≤C≤0.25%,
0.8≤Mn≤1.8%,
0.1%≤Si≤0.35%,
0.01≤Cr≤0.5%,
Ti≤0.1%,
Al≤0.1%,
S≤0.05%,
P≤0.1%,
B≤0.005%,
the rest being being iron and impurities from smelting.

52. The method according to claim 49, wherein the steel of the substrate comprises, by weight:
0.040%≤C≤0.100%,
0.80≤Mn≤2.00%,
Si≤0.30%,
S≤0.005%,
P≤0.030%,
0.010%≤Al≤0.070%,
0.015%≤Nb≤0.100%,
Ti≤0.080%,
N≤0.009%,
Cu≤0.100%,
Ni≤0.100%,
Cr≤0.100%,
Mo≤0.100%,
Ca≤0.006%,
the rest being iron and impurities from smelting.

53. The method according to claim 49, wherein the microstructure of said steel is ferrito-pearlitic.

54. The method according to claim 34, wherein, during the provision step, two pre-coated metal sheets are supplied and they are arranged side by side, leaving a predetermined gap between the two pre-coated metal sheets, then,
during the removal step, at least part of the pre-coating layer is simultaneously removed from each of the two metal sheets in order to simultaneously form a removal zone on each of said metal sheets, the laser beam being arranged overlapping the two metal sheets during the removal step.

55. The method according to claim 34, wherein the removal zone is located at the periphery of the metal sheet.

56. The method according to claim 34, wherein the removal zone is not completely adjacent to the edge of the metal sheet.

57. The method according to claim 56, further comprising, after the removal step to form the removal zone, cutting of the metal sheet along a plane so as to form a metal sheet comprising, at its periphery, a zone free of at least part of the pre-coating layer.

58. A metal sheet comprising a metal substrate bearing, on at least one of its faces, a pre-coating layer, the metal sheet comprising, on said at least one face, a removal zone where the pre-coating layer has been removed over part of its thickness, wherein
in the removal zone, the relative variation A, considered along the width of the removal zone, of the thickness of the part of the pre- coating layer remaining in the removal zone, defined by the ratio of the difference between the pre-coating thickness at half-width and the pre-coating thickness at one third of the width considered from the edge of the removal zone to the thickness of the pre-coating at half- width, is strictly greater than 0% and less than or equal to 50.

59. The metal sheet according to claim 58, wherein the pre-coating layer comprises a layer of intermetallic alloy topped by a layer of metal alloy.

60. The metal sheet according to claim 59, wherein the removal zone is completely free of the layer of metal alloy.

61. The metal sheet according to claim 58, wherein the removal zone is located at the periphery of the metal sheet.

62. The metal sheet according to claim 58, wherein the removal zone is not completely adjacent to the edge of the metal sheet.

63. A method for manufacturing a welded blank, comprising the following successive steps:
providing at least two metal sheets according to claims 25 to 28 or obtained from at least one metal sheet according to claim 29 by cutting in the removal zone so as to obtain a metal sheet comprising, at its periphery, a zone free of at least part of the pre-coating layer or manufactured according to the method according to claims 34 to 55 and 57, then
butt welding these two metal sheets, the welded connection being done on the edge comprising the removal zone.

64. The method according to claim 63, wherein the two butt welded metal sheets have different thicknesses.

65. A method for manufacturing a hot pressed part comprising the following successive steps:
providing a welded blank obtained using the method according to claim 63, then heating said welded blank so as to impart a partially or fully austenitic structure to the substrates of the metal sheets making up said blank, then
hot press-forming said blank to obtain a hot pressed part;
cooling the part with a speed able to give it targeted mechanical properties.

66. The method according to claim 65, wherein the cooling speed is greater than the critical martensitic quenching speed of the steel of the substrate of said at least two metal sheets or the steel of the substrate of said at least one metal sheet.
